(19) United States
(12) Patent Application Publication
(10) Pub. No.: US 2025/0337441 A1
(43) Pub. Date: Oct. 30, 2025

(54) REMOTE ANTENNA WITH DIGITAL FIBER OPTIC LINK

(71) Applicant: Sound Devices LLC, Reedsburg, WI (US)

(72) Inventors: Matthew G. Anderson, Madison, WI (US); Gary Trenda, Portage, WI (US); Cody Heimann, Nashville, TN (US)

(73) Assignee: Sound Devices LLC, Reedsburg, WI (US)

(21) Appl. No.: 19/188,649

(22) Filed: Apr. 24, 2025

Related U.S. Application Data
(60) Provisional application No. 63/638,824, filed on Apr. 25, 2024.

(51) Int. Cl. H04B 1/04; H04B 1/00; H04B 10/25; H04B 14/02

(52) U.S. Cl. CPC H04B 1/04; H04B 1/0003; H04B 10/25; H04B 14/02

(57) ABSTRACT

A wireless RF connection provides relocatable transmitter and/or receiver antennas utilizing digital fiber optic connections to provide improved resilience of relocatable RF antennas. Improved robustness against suboptimal performance of various optical components is realized by the introduction of serial, bit stream transmission of in-phase and quadrature modulation data (I, Q data).

### CROSS-REFERENCE TO RELATED APPLICATION

The present application claims priority of U.S. Provisional Patent Application No. 63/638,824, filed Apr. 25, 2024, the content of which is incorporated herein by reference in its entirety.

### FIELD OF THE INVENTION

The disclosed invention provides means to improve the reliability and cost effectiveness of using a relocatable antenna to transmit audio data via modulated radio frequency (RF) transmission, or to receive RF transmitted RF audio data. Flexibility in the placement of transmit and/or receive antennas enables optimized antenna placement to boost the level of RF coupling between each antenna. Historically, the implementation of relocatable antennas has been hampered by issues of a relatively high cost for components required to ensure high reliability. This has especially been the case where an optic link is provided between a transmitting base and the remote transmitting antenna wherein light intensity transmitted through fiber optic media is modulated. The invention disclosed provides for a reduction in cost while at the same time offering improvements in expected reliability.

### BACKGROUND

Due to the high degree of convenience and freedom they offer for movement, the use of wireless audio devices has seen a dramatic increase in use over the last several years with many new products being successfully marketed. A side from the convenience of eliminating any concerns regarding a corded connection, not all wireless devices are created equal. Wireless audio devices typically function by digitizing an input audio signal and wirelessly transmitting the digital audio data to some form of a receiving station. In order to properly receive digitized audio data, a persistent radiofrequency (RF) pathway must exist between the transmitting device and receiving station that allows for the propagation of electromagnetic (radio) waves at a sufficient power, bandwidth and signal-to-noise ratio (SNR) to sustain the transfer of digital data. In audio recording systems, the use of quadrature phase-shift keying (QPSK) to modulate the carrier RF frequency is widespread. QPSK modulation is desirable since the same amount of data can be transmitted with half the bandwidth if binary phase-shift keying is used.

A common problem that has been historically encountered with wireless audio equipment is that the RF energy emitted by a transmitting antenna can construct an interference pattern throughout the vicinity of the operating environment for both it and a paired receiving antenna. If in such an environment, the receiving antenna is placed in a node (null) for the interference pattern, RF levels may fall below a threshold such that the signal-to-noise (SNR) ratio provided to the receiving antenna cannot support the rate of data transfer required for proper operation of the audio system. In general, these patterns can be difficult to predict; so proper placement of a transmitting antenna to avoid such problems can be a hit or miss proposition. Usually, a more prominent location for the antenna is desirable (for example, such as where the receiving antenna is in the line of sight for the transmitting antenna), but desirable locations may not be well suited for the positioning of supporting audio equipment such as on or near an equipment rack or cart, which is likely to be quite noisy.

Traditional attempts to mitigate connectivity issues between a transmitting and receiving antennas include the positioning of remote antennas at a better location where they may serve as a substitute for (in place of) poorly located transmit and receive antennas. For example, if an equipment cart is located at a suboptimal location for a transmit antenna, a physical (wired) connection may be provided between it and an auxiliary (remote) transmit antenna, placed at a preferred location some distance from the equipment cart. Since the supporting electronics for such a remote antenna may be made much smaller, it will likely prove less obtrusive for it to be placed in a more prominent (visible) space than the supporting equipment. Likewise, a similar relationship may exist at the receiving side of an RF connection, where a remote receiving antenna may be conveniently placed at a more prominent location. Difficulties with this approach may arise when a significant distance exists between the transmitting device or receiving station and a corresponding remotely placed antenna. In these cases, low-loss coax cables may provide a suitable means to electrically connect the transmitter or the receiver to a remote antenna. However, low-loss coaxial cabling is both expensive and large in diameter, such that it often proves cumbersome for production personnel who are responsible for configuring audio systems and managing the audio systems during performances.

Attempts have been made to alleviate cabling issues by coupling remote antennas to transmit and receive devices via fiber optic cable. The modulated electrical signal that would normally drive the antenna is converted to an optical analog signal for transmission over the fiber optic cable and is converted back to replicate the modulated electrical signal to drive the antenna. However, this approach has been problematic, as the dynamic range of RF signaling often exceeds the limited dynamic range available for the modulation of fiber-optic intensity. As such, cumbersome manual gain adjustment or automatic gain adjustment circuitry may be needed to cope with the limited dynamic range, compromising the RF performance. This is further aggravated by the fact that unless high quality fiber with very few splices is used, signals levels may end up being attenuated too far to be useful. An advantage of using fiber optics is the immunity that fiber-optic connections provide with respect to electromagnetic interference (EMI).

### SUMMARY OF THE INVENTION

The invention overcomes the limitations of transmitting analog signals over the fiber optic cable by converting the modulated signal to a digital (ON/OFF) format and transmitting serial data through the fiber optic link, thereby taking advantage of the extremely high bandwidth generally inherent to fiber optic links.

In one aspect, the invention is directed to a transmitting audio device with a relocatable transmitting antenna connected with a fiber optic cable through which a series of light pulses is transmitted rather than transmitting an analog signal. The relocatable transmitting antenna includes a transmitter base that is configured to process digital input audio data (e.g. converting PCM data). The transmitter base preferably includes a modulator that applies a 4PSK or 8PSK protocol to generate I, Q data, where the I component represents in-phase keying, and the Q component represents quadrature keying. The transmitter base converts the I, Q data into a serial bit stream, e.g., representing a series of on/off states. The bit stream can contain other multiplexed data as well. An electrical-to-fiber converter (E2F coupler) on the transmitter base receives the serial bit stream and outputs a series of light pulses for transmission through a fiber optic cable.

The relocatable transmitting antenna unit has a fiber-to-electrical converter (F2E coupler) that receives the series of light pulses from the fiber optic cable and outputs a bit stream corresponding to the bit stream on the transmitter base. The bit stream is converted and the I,Q data is extracted on a processor, such as an FPGA, on the relocatable antenna unit. The I,Q data is converted to analog signals that are used to modulate an analog carrier signal from a local oscillator, resulting in an IQ modulated analog waveform that is filtered and amplified prior to driving the transmitting antenna to broadcast an IQ modulated RF signal. Using the invention, long lengths of fiber optic cable can be used between the transmitter base and the antenna unit without the risk of data loss or EMI interference. A receiver or receiver station receives the IQ modulated RF signal and outputs digital audio data replicating the digital input audio data. The receiver may have a relocatable antenna unit, but this is not necessary to implement the invention on the transmitter side.

Notably, the system can be implemented with more than one relocatable transmit antenna unit. In this case, each relocatable transmit antenna unit is connected via a dedicated fiber link to the transmitter base. The transmitter base interleaves a synchronization signal within the bit stream of serialized I, Q data, and the synchronization signal is extracted by the FPGA on the respective relocatable transmit antenna units and used to synchronize the local oscillators on all the relocatable transmit antenna units. In this way, the IQ modulated RF signals transmitted from the relocatable antennas are synchronized.

In the exemplary embodiment, the transmitter base includes an FPGA that is programmed to implement the functions of an audio encoder to reduce the audio bit rate from that of the digital input audio data, and the modulator. The preferred FPGA has a Gigabit serial transceiver that serializes the FPGA output data. The E2F coupler is preferably a standard small-form pluggable (SFP) optical interface that is connected to the Gigabit serial transceiver. The relocatable transmitter unit in the exemplary embodiment has an F2E coupler that is preferably a standard small-form pluggable (SFP) optical interface, and an FPGA with a built-in Gigabit serial transceiver, as well as the analog components discussed above. The FPGA is configured to send to I, Q data to an analog-to-digital converter and set the local oscillator.

In some embodiments, it may be desired that power conducting lines extend between the transmitter base and the relocatable transmitting antenna unit.

Another aspect of the invention is directed to implementing the invention on the receiver side. In this aspect, the receiver station is connected to a relocatable receiving antenna unit with a fiber optic cable through which a series of light pulses is transmitted rather than transmitting an analog signal. The relocatable receiving antenna unit detects a broadcasted RF signal with a receiving antenna. The signal is preferably an IQ modulated waveform. The analog signal is filtered through a bandpass filter, amplified, and down converted. The down conversion process input a signal from a local oscillator and strips the carrier signal leaving an analog IQ signal. The analog IQ signal is digitized to create I, Q data, which is serialized to create a bit stream containing the I, Q data. The I, Q bit stream inputs an E2F coupler that outputs a series of light pulses over the fiber optic cable through which the series of light pulses is transmitted. The receiving station has an F2E coupler that receives the light pulses and a processor (e.g. an FPGA) having a transceiver that is configured to input the bit stream and convert it to I, Q data. The I, Q data is then demodulated (4, 8-PSK), decoded and decompressed to generate digital output audio data (PCM) which is a reproduction of the digital input audio data (PCM) inputting the transmitter side.

In similar fashion to the transmitter side, the invention can be implemented on the receiver side with more than one fiber linked, relocatable receiver antenna unit. In this case, each relocatable receive antenna unit is connected via a dedicated fiber link to the receiver station. As explained previously, the invention can be used to add a relocatable antenna unit with a fiber optic connection to an audio transmitter base in one aspect of the invention and to add a relocatable antenna unit with a fiber optic connection to an audio RF receiver station in another aspect of the invention. Relocatable antenna units can be contemporaneously added to both the transmitter side and the receiver side or added to only one side of the RF connection.

One of the advantages of the invention is that QPSK modulation can modulate multiple channels of audio data and output I, Q data that represents the audio data of the multiple channels. As an example, sixteen (16) channels of digital audio data can be represented in the I, Q data resulting from multi-channel modulator processing. In accordance with the invention, the I, Q data is then be serialized and transmitted over a single optical fiber link to the relocatable transmit antenna unit. Additional fiber links or multiplexing, via time multiplexing or wavelength multiplexing, should not be needed in most circumstances to transmit serialized, multi-channel I, Q data. On the relocatable transmit antenna unit, the I, Q data are extracted, converted to analog and used to modulate the carrier frequency, resulting in a multi-channel IQ modulated analog waveform. The IQ modulated multi-channel analog waveform drives the antenna to broadcast an IQ-modulated, multi-channel, RF signal.

Similarly, a receiver side with a fiber linked, relocatable antenna can take advantage of I, Q data being capable of representing audio data of the multiple channels. For example, the receiver antenna detects an IQ-modulated, multi-channel, RF signal the antenna outputs an IQ-modulated, multi-channel, analog waveform. This waveform is processed to create an analog signal representing the multi-channel I, Q components of the waveform. The analog signal is digitized and then serialized to form a bit stream containing multi-channel I, Q data, which is transmitted over the fiber link. The receiving station is configured to demodulate the multi-channel I, Q data, which is then decoded and decompressed, resulting in multiple channels of audio output data (PCM).

If the number of channels exceeds the number that can effectively be transmitted via multi-channel I, Q data, or if otherwise desired, transmission of data for different channels over the fiber optic link can occur at different wavelengths or can be multiplexed. Many aspects of the invention have been described in connection with single fiber links to relocatable antennas, yet those skilled in the art will appreciate that invention can be extended to system having an additional fiber connection to and from the relocatable antenna unit. An additional fiber connection may be useful to transmit control and configuration data, or meta data in the reverse direction. Also, various types of multiplexing can be implemented to communicate over a fiber optic link in a bi-directional manner, such as time division multiplexing or wavelength multiplexing.

### BRIEF DESCRIPTION OF THE DRAWINGS

A more complete appreciation of the present invention and the attendant advantages and features thereof will be more readily understood by reference to the following detailed description when considered in conjunction with the accompanying drawings.

FIG. 1 is a block diagram illustrating a fiber-interfaced relocatable transmitting antenna according to an exemplary embodiment of this invention.

FIG. 2 is a block diagram illustrating a fiber-interfaced relocatable receiving antenna according to another exemplary embodiment of this invention.

FIG. 3 is a diagram illustrating I, Q data representing multi-channel audio being transmitted over an optic fiber link to a relocatable transmitting antenna according to a third exemplary embodiment of this invention.

FIG. 4 is a diagram illustrating I, Q data representing multi-channel audio being transmitted over an optic fiber link from a relocatable receiving antenna unit to a receiver station according to a fourth exemplary embodiment of this invention.

### DETAILED DESCRIPTION THE INVENTION

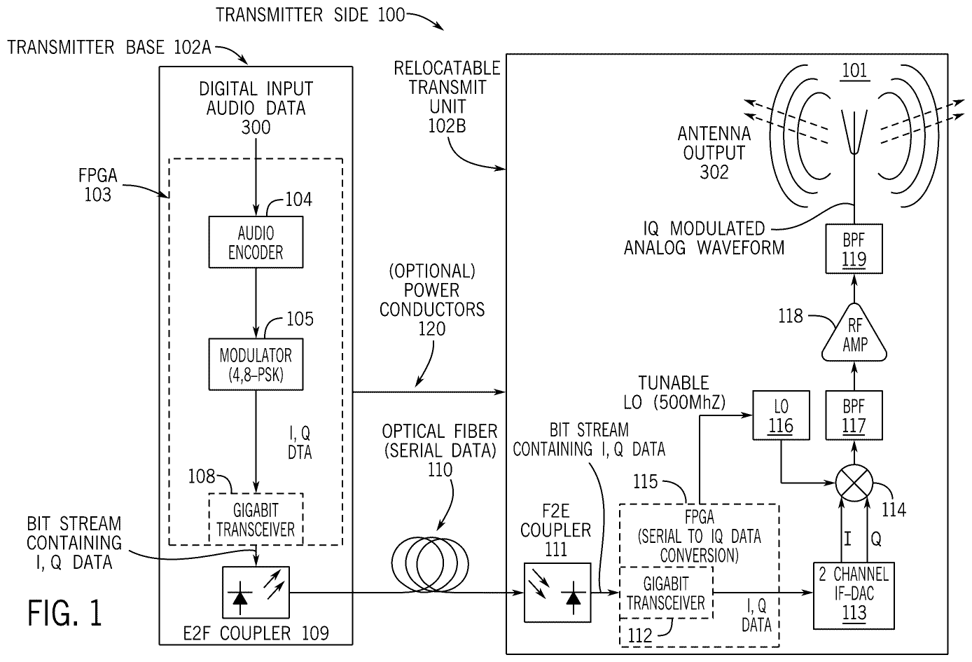

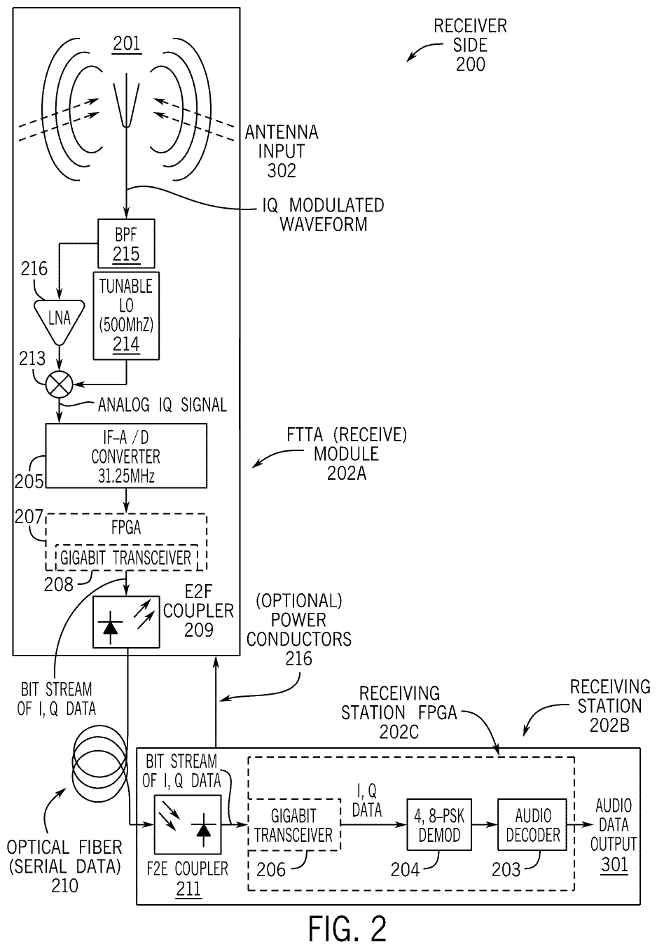

According to a first exemplary embodiment of the invention, a transmitting side 100, see FIG. 1, for a remote antenna transmitting system includes a transmitter base 102A where a source of digital audio input data 300 (e.g. PCM) to be wirelessly transmitted is accessible. The transmitter base 102A is physically connected via a fiber optic cable 110 to a relocatable transmitting antenna unit 102B that may be physically placed at a location that is advantageous for the wireless transmission of data to one or more receivers, one of which can be the receiving side 200 described in FIG. 2. FIG. 2 illustrates the coupling of a fiber optic connection 210 between a receiving station 202B and a relocatable FTTA (fiber-to-the-antenna) receiving antenna unit 202A that contains a relocatable receiving antenna 201. It should be understood that the simultaneous coupling of both a relocatable transmit antenna 101 and relocatable receive antenna 201 to a respective transmitting device or receiving station are not required to implement the invention. In fact, the configurations described in FIG. 1 or in FIG. 2 may be independently applied to the transmitter side 100, see FIG. 1, or the receiver side 200, see FIG. 2, to provide flexibility in the physical placement for these respective antennas, as part of an RF data link.

The embodiment of FIG. 1 describes the connection for a single-channel, digital audio input source 300 that is to be wirelessly transmitted over a relocatable antenna 101. The applicability for the embodiment described here is in no way limited by the audio processing used to produce the audio source 300. It should be understood that the digital input audio data 300 may have been derived from one or more sources of audio data that may have been processed using a variety of signal processing methods such as: noise reduction, mixing, recording playback, live recording or the live output of musical instruments and/or performers. For example, for some embodiments, the digital input audio data 300 may consist of 32-bit integer or floating-point digital data having a sample rate of 48 KHz. In the embodiment in FIG. 1, the digital audio data rate is reduced by applying an audio encoder 104 that may include variants of an ADPCM (adaptive differential pulse-code modulation) algorithm. In most cases, since the fiber optic portion for the connection 110 can generally support extremely high data rates, the most obvious benefit of reducing the digital audio rate with an audio encoder 104 is the mitigation of the bandwidth requirements for the RF link connecting between the relocatable transmitting antenna 101, FIG. 1, and a receiving antenna such as antenna 201 in FIG. 2. In a preferred embodiment, the functions of the audio encoder 104, the modulator 105 and the gigabit transceiver 108 are implemented on a single FPGA 103 that physically operates inside the transmitter base 102A. Suitable exemplary FPGAs include Xilinx Zynq7015 and Xilinx UltraScale+ MPSoc (XCZU3TCG) both provided by Advanced Micro Devices, Inc. Both of these FPGAs include built-in gigabit serial transceivers.

For other embodiments, a general-purpose microprocessor or DSP may prove suitable in place of the FPGA 103. For example, FCC regulations may place constraints on the available signal power and bandwidth used in the RF link from the transmitting antenna 101, FIG. 1.

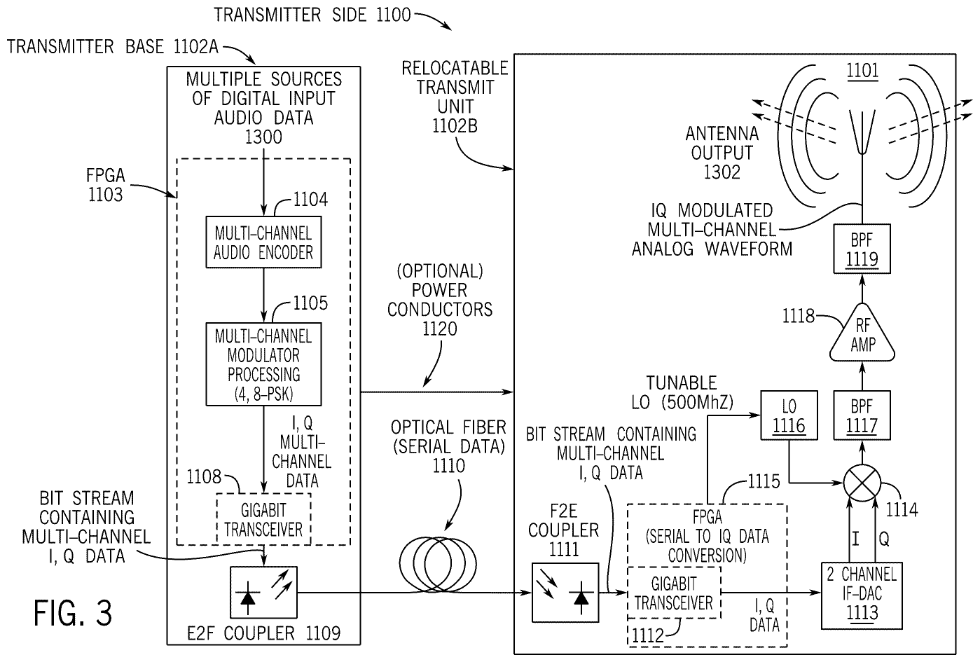

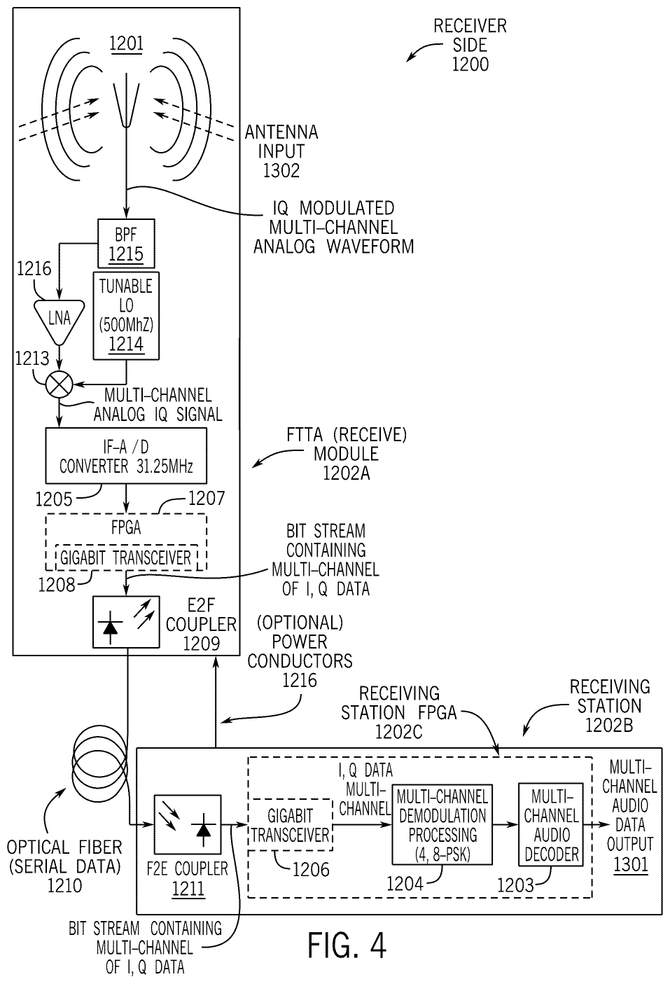

In the exemplary embodiments, the E2F (electrical-to-fiber) and F2E (fiber-to-electrical) couplers are inexpensive small-form-pluggable modules (SFP modules), such as the generic 10GBASE-SR SFP+ transceiver module supplied at FS.com. The SFP modules provide convenient means to interface the E2F coupler 109 to the fiber cable 110 as well as interfacing the fiber cable 110 to F2E coupler 111. Communication lines on the printed circuit board run from the FPGA, more specifically from the gigabit serial transceiver on the FPGA, to a connector that connects to one end of the SFP. The fiber cable plugs into the other end of the SFP. The above identified FPGAs and SFP module are suitable for use on the transmitter side 100 shown in FIG. 1 and the receiver side shown in FIG. 2, as well as the multi-channel embodiments illustrated in FIGS. 3 and 4.

For the sake of example, the systems described here include the use of a relocatable antenna 201 in the receiving side of a wireless system 200, FIG. 2, coupled to another relocatable antenna 101 in the transmitter side 100, FIG. 1, of the wireless communication system. However, as discussed previously, the invention contemplates placing a relocatable antenna on only one side (the transmitting side 100 (FIG. 1) or the receiving side 200 (FIG. 2)) of the wireless system as well. In these cases, the side of the wireless system that does not include the use of a relocatable wireless antenna (101 or 201) may employ a standard (fixed or non-relocatable) antenna in accordance with the prior art. A significant advantage of this invention is that for some embodiments, it may be optionally applied to both ends (i.e. both for transmitting and receiving antennas) or to only one of either the transmitting or receiving end of a wireless data connection without the need for making alterations to the other end. Flexibility exists in that the choice of which side (receiving or transmitting) to employ a relocatable antenna in a wireless system may be made depending on the particular needs of the application (and environment) at hand.

Referring in particular to FIG. 1, within a transmitter base 102A, the digital input audio data 300 may have been previously recorded, supplied by another device or for some embodiments, derived by combining or processing a plurality of audio sources in order to derive digital input audio data 300 that is to be wirelessly transmitted to a receiving device. The receiving device may be an earpiece worn by a performer or a base unit worn by the performer and connected to the earpiece. In fact, the RF signal transmitted from the transmitter antenna 101 can be received by multiple devices, e.g. received by the earpieces or base units worn by several different performers. In some embodiments, the digital input audio data 300 may take the form of integer values having from 8 to 32 bits per word for each data sample. The sampling frequency of the digital input audio data may often be preferred at a 48 KHz rate. It may be single channel as shown in FIG. 1, or may be multiple channel data as shown in FIG. 3. Since this data will ultimately be carried by an RF signal between a transmitting antenna 101 and receiving antennas, it may be preferable to lower the required bandwidth by reducing the audio bit rate by applying an audio encoder 104 to the audio data stream 300, as noted previously. This may prove helpful in instances where RF emissions (power and bandwidth) are regulated (and restricted) by government agencies, such as the FCC. For some embodiments, the bit rate at the output of the audio encoder 104 may range from 192 kbps to 384 kbps per audio channel. For other embodiments, there may be no need for the audio encoder 104 if sufficient RF bandwidth is available. Following the audio encoder 104, a modulator 105 converts the encoded/compressed audio to data to in-phase and quadrature (I,Q) modulated data 107. In the preferred embodiments, either a 4PSK or 8PSK (phase-shift keying) modulation scheme 105 is used, where encoded points lie on a ring at equal distances from the origin of the IQ plane and at equal angles from each other. The modulator 105 uses a reference signal with an intermediate frequency, e.g. 31.25 MHz although other intermediate frequencies may be suitable to implement the modulation and output the I, Q data. Binary phase shift keying (BPSK) is sometimes considered to be an alternative modulating and demodulating procedures to 4PSK and 8 PSK, but in the context of this invention BPSK is considered to be a subset of 4PSK or 8PSK modulation in which case the modulated output would not include a quadrature stream.

Referring still to FIG. 1, the I, Q data 107 from the modulator 105 is then supplied as the input to a built-in, serial (Gigabit) transceiver 108, which serializes the data into a series or bit stream of ON/OFF states. The conversion to serial data highlights one of the most salient advantages of the disclosed invention since the bit stream of data is efficiently converted by the electrical to fiber (E2F) coupler 109 from electrical (data) to light pulses are optically transmitted via the physically connected fiber optic cable 110 to the location of the remote transmit antenna unit 102B. Fiber optic cables and their associated converters typically offer a limited dynamic range which is an issue when transmitting analog signals. For example, the dynamic range for a fiber to electric converter 111 at the other end of the fiber connection is often limited to only about 50 dB. Although fiber optic components may provide limited dynamic range, they generally are capable of offering extremely high bandwidths (e.g., operating at speeds up to and beyond 10 Gbps) that will easily accommodate a serial binary transmission format with a far greater degree of robustness than is the case for the analog transmission of data via a fiber link. Converting the fiber communications link to binary form mitigates the need to allow only a few high-quality splices in the fiber connection and offers greatly improved resilience against attenuation of the fiber light pulses due to suboptimal fiber quality and/or interfacing.

Light pulses representing the serial output of the transceiver 108 may utilize a commonly used wavelength of 1310 nm. These pulses can travel over the fiber optic cable 110 from the physical location of the transmitter base 102A to that for the relocatable transmitter antenna unit 102B supporting the remote transmitting antenna 101 that has been placed at a location to better facilitate RF communication with any intended receiving antennas.

When light pulses travelling through the fiber optic cable 110 reach the remote transmitting antenna 102B, they are converted to a serial electrical bit stream by a fiber to electrical (F2E) coupler 111. This bit stream is processed by an FPGA based serial to PCM (Gigabit) transceiver 112 to extract the I, Q data 107 that is a replica of the I,Q data 107 that was previously encoded by the Gigabit serial transceiver 108 in the transmitter base 102A. The preferred embodiment may utilize the IEE1588 protocol for maintaining synchronization of the clocks used in serial coding (at 108) and decoding (at 112). The resultant IQ data is then converted to an analog I signal and an analog Q signal using a two-channel intermediate frequency (e.g. 31.25 MHz) digital-to-analog converter (IF-DAC) 113. The analog I and Q signals are applied to an IQ modulator 114 that is driven by a local oscillator 116 turned to the desired frequency band for transmission resulting in an IQ modulated analog waveform. The IQ modulated analog waveform is filtered by a tunable BPF 117 and subsequently amplified by an RF amp 118. The amplified electrical output is then conditioned using a final channel BPF 119 to drive the RF output 302 of the relocatable antenna 101 to broadcast RF waveforms 302.

In many applications, it will be desirable to connect more than one relocatable transmit antenna unit 102B to the transmitter base 102A. In these cases, each relocatable transmit antenna unit 102B is connected via a dedicated fiber link 110 to the transmitter base 102A via different plugs on the Gigabit serial transceiver 108. The FPGA 103 interleaves a synchronization signal within the bit stream of serialized I, Q data, and the synchronization signal is transmitted to each of the relocatable transmit antenna units 102B. The synchronization signal is extracted by the FPGA 115 on the respective relocatable transmit antenna units 102B and used to synchronize the local oscillators 116 on all of the connected relocatable transmit antenna units 102B. In this way, the IQ modulated RF signals transmitted from the relocatable antennas are synchronized.

Certain advantages of this invention are apparent when describing a relocatable transmitting antenna system 100, FIG. 1, also apply to the receiving side 200, FIG. 2, of wireless RF connections. For the sake of facilitating understanding of the operation of the invention on the receiver side 200, it is insightful to consider reciprocating (or in large part, reversing) the operations applied at the transmitting side 100, FIG. 1, to the RF signals 302 received by the relocatable receiving antenna 201 in FIG. 2 to extract the original input audio data 300 (FIG. 1) broadcast from the transmitter side 100, or a different transmitter not using a fiber linked relocatable antenna as described above.

Turning to FIG. 2, this diagram illustrates an exemplary embodiment of the invention applied to the receiver side 200 of the wireless RF link. The antenna 201 in FIG. 2 receives an IQ modulated RF signal. In an analogous fashion to the relocatable transmitter antenna unit 102B (FIG. 1), the relocatable receiving antenna 201 (FIG. 2) may be placed at a prominent location that is advantageous for the reception of RF energy emitted by a transmitter antenna 101 that is carrying data 302. The received signal 302 (labelled antenna input 302 in FIG. 2) is detected by the receiver antenna 201 which outputs an electrical signal representing the IQ modulated analog waveform. The electrical signal is input to a band pass filter 215 (designed to isolate the desired RF signal). The filtered signal is then amplified by a low-noise-amplifier (LNA) 216 that generates output connected to a demodulator 213 that down-converts the base frequency of the modulated information and strips out the carrier frequency based on a tunable local oscillator 214. The down converted, analog output signal contains analog IQ data and is labelled on FIG. 2 as Analog IQ Signal. The analog IQ signal is input to a high-speed analog-to-digital (ADC) 205 converter running at 31.25 MHz for example, to produce an output digital I, Q data. In the case that the transmitting antenna is the system in FIG. 1, the I, Q data output from the ADC 205 is a replica of the digital I, Q data output from the modulator 105 on the transmitter base 102A. The I, Q data output from the ADC 205 is input to an FPGA 207 with a built-in Gigabit serial transceiver 208 and the I, Q data is converted to serial bit stream of I, Q data. The Gigabit serial transceiver 208 transmits the serial bit stream to an E2F coupler 209 that converts to the bit stream to optical pulses of light. The optical data is transmitted over a fiber optic cable 210 to an F2E coupler 211 on the receiving station 202B (which would typically be placed at a different location from the location of the receiving antenna 201, such as on an equipment cart).

The serial output from the F2E coupler 211 on the receiver station 202B is a bit stream of I, Q data and it is input to the Gigabit serial transceiver 206 on FPGA 202C on the receiver station 202B, which converts it to I, Q data in PCM format In the case that the transmitting antenna is part of the transmitter side 100 shown in FIG. 1, the PCM I,Q data 207 is substantially a replica of the I,Q data output from the modulator 105 on the transmitter base 102A in FIG. 1. From here, the FPGA 202C in the receiving station 202B is configured to demodulate and decode the PCM I, Q data, see blocks 204 and 203 within the receiving station FPGA 202C in FIG. 2. The demodulator 204 uses a reference signal having the intermediate frequency (e.g. 31.25 MHz), and 4-PSK or 8-PSK depending on the modulation method used to modulate the transmitted signal. After decoding with a decoder 203 that is compatible with the encoder 104 used on the transmitter side, such as the transmitter side 100 in FIG. 1, PCM audio data 301 is output. The PCM audio data output 301 in FIG. 2 represents the original input audio data 300 in the case that the transmitter side is that shown in FIG. 1. As shown, the receiving station FPGA 202C is configured to perform the functions of the Gigabit transceiver 206, the 4,8PSK demodulator 204 and audio decoder 203.

It is important to understand that the conversion of the I, Q data to a series of ON/OFF pulses provides advantages over the analog transmission of data over the fiber optic cables as previously described. In particular, the digital serial data format offers greatly improved robustness in the event of suboptimal fiber quality and interfacing or attenuation of light pulses due to connectivity related issues.

Another optional feature is to provide power to the relocatable transmit antenna unit 102B from the transmitter base, 102A, along a set of power conductors 120. In the case of the relocatable receiving antenna unit 202A, it may be preferable for the receiving station 202C to provide a power supply to the FTTA receiving antenna unit 202A along a set of conductors 216. In either case, power may be routed via conductors 120 placed alongside the fiber optic cable 120, FIG. 1 (on the transmitter side 100) or along conductors 216, FIG. 2 (on the receiver side 200). Connectors to facilitate this are available from Neutrik and Optical Con that include optical and wired connectors arranged in an XLR style configuration. For these embodiments, the conductor cables (120, FIG. 1 or 216, FIG. 2) may run alongside the fiber cable (100, FIG. 1, or 216, FIG. 2, respectively) in the same cable housing (surround). Alternatively, in other embodiments, routing a harness of cables containing both optical and conductive elements may be suitable.

For many embodiments, a DC supply, e.g. including a local battery or rechargeable battery, of up to 48V may be suitable for providing power to the relocatable transmit antenna 102B or the FTTA receive module 202A. Other embodiments using an A C power supply (that may be coupled by transformers) are also anticipated by this disclosure. The provision of a power supply (and the inclusion of a conductive connection (cabling) 120 or 216, respectively, for the transmitter side 100 or receiver side 200 is an option that may be independently applied to either side. As discussed above, one of the advantages of the invention is that QPSK modulation can modulate multiple channels of audio data and output I, Q data that represents the audio data of the multiple channels. FIG. 3 illustrates the transmitting side 1100 of a multi-channel audio system. In FIG. 3, the reference numbers correspond to those in the FIG. 1, except 1000 is added to the reference numbers in FIG. 1. Some components on the multi-channel transmitter side FIG. 3 are identical to FIG. 1 and some are modified to accommodate multi-channel operation. Notably, the components in the FPGA 1103 on the transmitter base 1102A are modified to accommodate multi-channel audio 1300, but there are no material differences in converting the I,Q data to a bit stream whether it represent a single channel of audio or multiple channels of audio and no material difference in the transmission of the optical signal to the relocatable transmit antenna unit 1102B or the operation of the relocatable transmit antenna unit 11102B. FIG. 3 illustrates multiple sources of digital audio input channels 1300, which could be separate files of PCM audio data. The multiple channels of audio are input to a multi-channel audio encoder 1104, which are common in art often accommodating up to 64 channels of audio. The multi-channel encoder 1104 is conceptually similar to single channel encoder 104 in FIG. 1 and is used primarily to compress data. Block 1105 illustrates that the FPGA 1103 is configured or programmed to implement multi-channel 4 or 8-PSK modulation, using an intermediate frequency and as otherwise known in the art. The result of the multi-channel, modulator process is I, Q data representing the multiple channels of audio. In accordance with the invention, the I, Q data is then serialized by the Gigabit serial transceiver 1108 and transmitted over a single optical fiber link 1110 to the relocatable transmit antenna unit 1102B. Additional fiber links or multiplexing, via time multiplexing or wavelength multiplexing, should not be needed in most circumstances to transmit serialized, multi-channel I, Q data. On the relocatable transmit antenna unit 1102B, the I, Q data are extracted, converted to analog and used to modulate the carrier frequency in the same manner as described in FIG. 1, now resulting in a multi-channel IQ modulated analog waveform. The IQ modulated multi-channel analog waveform drives the antenna to broadcast an IQ-modulated, multi-channel, RF signal 1302. Like the single channel system of FIG. 1, synchronization is required if two or more antennas are connected.

Similarly, a receiver side with a fiber linked, relocatable antenna can take advantage of I, Q data being capable of representing audio data of the multiple channels. FIG. 4 illustrates the receiving side 1200 of a multi-channel audio system. In FIG. 4, the reference numbers correspond to those in the FIG. 2, except 1000 is added to the reference numbers in FIG. 1. Some components in the multi-channel receiver side 1200 in FIG. 4 are identical to FIG. 2 and some are modified to accommodate multi-channel operation. The components in the FPGA 11202C on the receiver station 1202B represented by blocks 1204 and 1203 are modified to accommodate multi-channel audio, but there are no material differences on the other hardware or programing on the relocatable antenna unit 1202A, or the operation of the Gigabit serial transceiver 1206 on the Receiving station FPGA 1202C. The receiver antenna 1201 detects an IQ-modulated, multi-channel, RF signal and the antenna 1021 outputs an IQ-modulated, multi-channel, analog waveform. This waveform is processed (1213-1216), as discussed in FIG. 2, to create an analog signal in this case representing the multi-channel I, Q components of the waveform. The analog signal is digitized (1205) and then serialized (1207, 1208) to form a bit stream containing multi-channel I, Q data, which is transmitted over the fiber link (1209, 1210, 1211). The Gigabit serial transceiver 1206 on the receiving station FPGS 1202C converts the bitstream to multi-channel I, Q data. The receiving station FPGA 1202c is configured to demodulate (1204) the multi-channel I, Q data, and to then decode and decompress (1203), resulting in multiple channels of audio output data (PCM) 1301.

If the number of audio channels exceeds the number that can effectively be transmitted via multi-channel I, Q data, or if otherwise desired, transmission of data for different channels over the fiber optic link can occur at different wavelengths or can be multiplexed. Many aspects of the invention have been described in connection with single fiber links to relocatable antennas, yet those skilled in the art will appreciate that invention can be extended to system having an additional fiber connection to and from the relocatable antenna unit. An additional fiber connection may be useful to transmit control and configuration data, or meta data in the reverse direction. The type of information would normally be interleaved with the transmitted bit stream containing I, Q data when being transmitted in the same direction as the bit stream. Also, various types of multiplexing can be implemented to communicate over a fiber optic link in a bi-directional manner, such as time division multiplexing or wavelength multiplexing.

The construction and arrangement for elements of systems and methods as shown above are exemplary (and alternative) embodiments meant to be illustrative only. Those skilled in the art may appreciate that modifications are possible without materially departing from the novel teachings and advantages of the subject matter disclosed. For example, in some embodiments selecting a modulation scheme other than 4,8-PSK may be suitable. Although the use of FPGAs is described herein, other suitable methods may include the use of DSPs microprocessors or dedicated application specific integrated circuits and/or logic gates. Furthermore, the use of alternative protocols utilizing preset code-words and phase-locked-loops as a substitute for IEEE1588 clock synchronization may prove useful and these are also envisioned within the scope of the invention.

1. A transmitting audio device comprising:
a transmitter base that is configured to process digital input audio data and output a series of light pulses;
a fiber optic cable through which the series of light pulses is transmitted;
a relocatable transmitting antenna unit that inputs the series of light pulses from the fiber optic cable and transmits an RF signal from a transmitting antenna;
wherein the transmitter base converts the digital input audio signal into a first serial bit stream characterized as a series of on/off states, said transmitter base including an electrical-to-fiber (E2F) coupler that receives the first serial bit stream and outputs the series of light pulses; and
wherein the relocatable transmitting antenna unit includes a fiber-to-electrical (F2E) coupler that receives the series of light pulses transmitted over the fiber optic cable and outputs a second serial bit stream, and the relocatable transmitting antenna unit converts the second serial bit stream to one or more analog signals that is modulated, filtered and amplified to produce an analog electrical signal that drives the relocatable transmitting antenna to output the RF signal.

2. The transmitting audio device recited in claim 1 wherein:
the transmitter base has an IQ modulator that uses an intermediate frequency to modulate the digital input audio signal or an encoded version of the digital input audio signal to form I, Q data that is applied to a first serial transceiver on the transmitter base that which serializes the I, Q data to generate the first serial bit stream;
the relocatable transmitting antenna unit has a second serial transceiver that converts the second bit stream to I, Q data that inputs an intermediate frequency, two-channel digital-to-analog converter on the relocatable transmitting antenna unit, wherein analog I and Q signals output the intermediate frequency, two-channel digital-to-analog converter;
the relocatable transmitting antenna unit has an IQ modulator that receives a carrier frequency from a local oscillator and the analog I and Q signals from the intermediate frequency, two-channel digital-to-analog converter, resulting in an IQ modulated analog waveform that is then filtered and amplified to produce the analog electrical signal that drives the relocatable transmitting antenna to output the RF signal.

3. The transmitting audio device recited in claim 1 further comprising power conducting lines between the transmitter base and the relocatable transmitting antenna unit.

4. The transmitting audio device recited in claim 1 wherein the transmitter base includes an audio encoder that reduces the audio bit rate from that of the digital input audio data.

5. The transmitting audio device recited in claim 2 wherein the IQ modulator on the transmitter base applies a 4PSK or 8PSK protocol to form the I, Q data.

6. The transmitter audio device recited in claim 5 wherein quadrature components in the IQ modulator are set to zero thereby effectively implementing a binary phase shift.

7. The transmitting audio device recited in claim 1 wherein the transmitter base includes an FPGA configured to implement the functions of an audio encoder, a modulator and the first serial transceiver.

8. The transmitting audio device recited in claim 1 wherein a local oscillator on the relocatable transmitting antenna unit is tunable.

9. The transmitting audio device recited in claim 1 wherein the relocatable transmitting antenna unit includes an FPGA configured to implement the functions of the second serial transceiver.

10. An audio data transmission system comprising the transmitting audio device recited in claim 1, and a receiver that receives the RF signal and outputs digital output audio data replicating the digital input audio data.

11. The audio data transmission system as recited in claim 10 wherein the receiver comprises:
a relocatable receiving antenna unit that receives the RF signal with a receiving antenna and outputs a second series of light pulses;
a second fiber optic cable through which the second series of light pulses is transmitted; and
a receiving station that is configured to input the second series of light pulses and output a digital audio signal.

12. The transmitting audio device recited in claim 1 further comprising additional relocatable transmitting antenna units each connected to the transmitter base via a dedicated fiber optic cable through which a series of light pulses representing the first serial bit stream is transmitted from the transmitter base to the respective relocatable transmitting antenna units, and the transmitter base provides a synchronization signal that is interleaved in the first serial bit stream and extracted from the second serial bit streams on the respective relocatable transmitting antenna units and used to synchronize the broadcasting of the RF signal from the respective relocatable transmitting antenna units.

13. An audio data transmission system comprising the transmitting audio device recited in claim 2, and a receiver that receives the RF signal and outputs digital output audio data replicating the digital input audio data; wherein the receiver comprises:
a relocatable receiving antenna unit that receives the RF signal with a receiving antenna and outputs a second series of light pulses;
a second fiber optic cable through which the second series of light pulses is transmitted; and
a receiving station that is configured to input the second series of light pulses and output a digital output signal; and
wherein the relocatable receiving antenna unit filters an analog signal representing the RF signal and down converts to recover an analog I, Q signal, and applies the resulting analog I, Q signal to an intermediate frequency analog-to-digital converter to generate I, Q data;
wherein the I,Q data is converted to a bit stream containing I, Q data which is fed to an E2F coupler on the relocatable receiving antenna unit to output the second series of light pulses over the second fiber optic cable; and
wherein the receiving station has a second F2E coupler that receives the second series of light pulses transmitted over the second fiber optic cable and outputs a bit stream containing the I, Q data which in turn a serial transceiver on the receiving station that converts I, Q data which is demodulated and decoded in the receiving station to form the digital output audio signal.

14. An audio data transmission system comprising the transmitting audio device recited in claim 1, and a receiver that receives the RF signal and outputs digital output audio data replicating the digital input audio data, wherein the digital input audio data is multi-channel digital input data, and the digital output audio data is multi-channel digital output audio data.

15. An audio data transmission system comprising:
the transmitting audio device recited in claim 2 wherein the digital input audio data is multi-channel digital input data; and
a receiver that receives the RF signal and outputs multi-channel digital audio data replicating the multi-channel digital input audio data; and
further wherein the I, Q data and the bitstreams containing the I, Q data characterize multiple channels of audio.

16. A audio receiving device comprising:
a fiber optic cable through light pulses are transmitted;
a relocatable receiving antenna unit receives an RF signal via a receiving antenna and outputs a series of light pulses to the fiber optic cable, wherein the relocatable receiving antenna unit is configured to convert the RF signal to an electrical analog signal and then to digital data, and includes a serial transceiver that converts the digital data to a first serial bit stream and an electrical-to-fiber (E2F) coupler that receives the first serial bit stream and transmits a series of light pulses;
a receiver station configured to process the series of light pulses and output audio data; wherein the receiver station includes an F2E coupler that receives the series of light pulses and outputs a second serial bit stream, and a serial transceiver that receives the second bit stream and output digital data, and processing means for processing the digital data and output audio data.

17. The audio receiving device recited in claim 16, wherein
the relocatable receiving antenna unit filters an analog signal representing the RF signal and down converts to recover an analog I, Q signal, and applies the resulting analog I, Q signal to an intermediate frequency analog-to-digital converter to generate I, Q data;
the I, Q data is converted to a bit stream containing I, Q data which is fed to the E2F coupler on the relocatable receiving antenna unit to output the second series of light pulses over the second fiber optic cable; and
wherein the second F2E coupler on the receiving station receives the second series of light pulses transmitted over the second fiber optic cable and outputs a bit stream containing the I, Q data which in turn is converted by the serial transceiver on the receiving station to I, Q data which is demodulated and decoded in the receiving station to form the digital output audio signal.

18. The audio receiving device in claim 17 wherein the RF signal contains multi-channel audio, and receiving device outputs multi-channel digital audio data; and
wherein the I, Q data and the bitstreams containing the I, Q data characterize multiple channels of audio.

19. The audio receiving device recited in claim 16 further comprising additional relocatable receiving antenna units each connected to the receiving station via a dedicated fiber optic cable through which a series of light pulses representing the first serial bit stream is transmitted from the respective relocatable receiving antenna unit to the receiving station.
